(19) United States
(12) Patent Application Publication
(10) Pub. No.: US 2023/0008964 A1
(43) Pub. Date: Jan. 12, 2023

(54) USER-CONFIGURABLE SPATIAL AUDIO BASED CONFERENCING SYSTEM

(71) Applicant: Meta Platforms, Inc., Menlo Park, CA (US)

(72) Inventors: Maria Fernandez Guajardo, Sunnyvale, CA (US); Isabel Tewes, San Francisco, CA (US)

(21) Appl. No.: 17/367,979

(22) Filed: Jul. 6, 2021

(51) Int. Cl. H04S 7/00; H04N 7/15; G06F 3/0481

(52) U.S. Cl. CPC H04S 7/304; H04N 7/157; G06F 3/04817; H04S 2420/01

(57) ABSTRACT

A client device receives an arrangement of at least a subset of participants of a virtual meeting. The client device additionally receives an audio stream for each participant of the subset of participants of the virtual meeting. For each participant of the subset of participants, the client device determines a location based at least in part on the received arrangement, and modulates the received audio stream of the participant based on the determined location. The client device generates a combined modulated audio stream by combining the modulated audio stream of each of the participants and plays the combined modulated audio stream.

### BACKGROUND

As the number of participants in a virtual meeting increases, it becomes more difficult for listeners to identify the participant that is speaking. For example, a listener may not be familiar with the voice of every participant in the virtual meeting, or the listener may be unable to distinguish the voice of two or more participants. In video-based conferencing systems, a visual indicator of who is speaking may be provided, however, this may not be available for voice-only conferencing systems. Moreover, using visual indicators in a video-based conferencing system may become impractical or ineffective as the number of participants that speak concurrently increases. Furthermore, in some situations (e.g., in an audio-only based conferencing system), it may not be convenient or desirable for the listener to be looking at a screen to obtain an identification of which participant is currently speaking. Thus, it would be beneficial to provide a non-visual mechanism to allow listeners to identify which participant is currently speaking in a virtual meeting.

### SUMMARY

A virtual meeting system provides an indication to a listener of a participant that is currently speaking by outputting the audio for the participant in a manner that causes the participant to perceive the audio originating from a predetermined location. The listener is then able to determine which participant is speaking based on the perceived origin of the audio. A client device receives an arrangement of at least a subset of participants of a virtual meeting. The client device additionally receives an audio stream for each participant of the subset of participants of the virtual meeting. For each participant of the subset of participants, the client device determines a location based at least in part on the received arrangement, and modulates the received audio stream of the participant based on the determined location. The client device generates a combined modulated audio stream by combining the modulated audio stream of each of the participants and plays the combined modulated audio stream

### BRIEF DESCRIPTION OF THE DRAWINGS

FIG. 1 illustrates a diagram of a virtual presence video meeting using an online system, in accordance with one or more embodiments.

FIG. 2 is a block diagram of a system environment in which an online system operates, in accordance with one or more embodiments.

FIG. 3 is a block diagram of an online system, in accordance with one or more embodiments.

FIG. 4 is a block diagram of a client devices 210, in accordance with one or more embodiments.

FIG. 5A illustrates a diagram for configuring a spatial audio based voice conference, in accordance with one or more embodiments.

FIG. 5B illustrates a diagram showing the audio output of the spatial audio based voice conference configuration of FIG. 5A.

FIG. 6A illustrates a diagram for configuring a spatial audio based voice conference, in accordance with one or more embodiments.

FIG. 6B illustrates a diagram showing the audio output of the spatial audio based voice conference configuration of FIG. 6A.

FIG. 7A illustrates a diagram for configuring a spatial audio based voice conference having participants divided into multiple groups, in accordance with one or more embodiments.

FIG. 7B illustrates a diagram showing the audio output of the spatial audio based voice conference configuration of FIG. 7A.

FIG. 8 illustrates a diagram for modulating the audio of each participant of a meeting, in accordance with one or more embodiments.

FIG. 9A illustrates a diagram for configuring a spatial audio based voice conference with multiple participants having a single location, in accordance with one or more embodiments.

FIG. 9B illustrates a diagram showing the audio output of the spatial audio based voice conference configuration of FIG. 9A.

FIG. 10A illustrates a diagram for configuring a spatial audio based voice conference with multiple participants having a single location, in accordance with one or more embodiments.

FIG. 10B illustrates a diagram showing the audio output of the spatial audio based voice conference configuration of FIG. 10A.

FIG. 11 illustrates a diagram for modulating the audio of each participant of a meeting with multiple users assigned to a single location, in accordance with one or more embodiments.

FIG. 12 illustrates a flow diagram for outputting audio for a spatial audio based voice conference, in accordance with one or more embodiments.

FIGS. 13A and 13B illustrate a block diagram for determining a location for participants of a meeting locked in real space, in accordance to one or more embodiments.

FIGS. 14A and 14B illustrate a block diagram for determining a location for participants of a meeting locked in virtual space, in accordance to one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

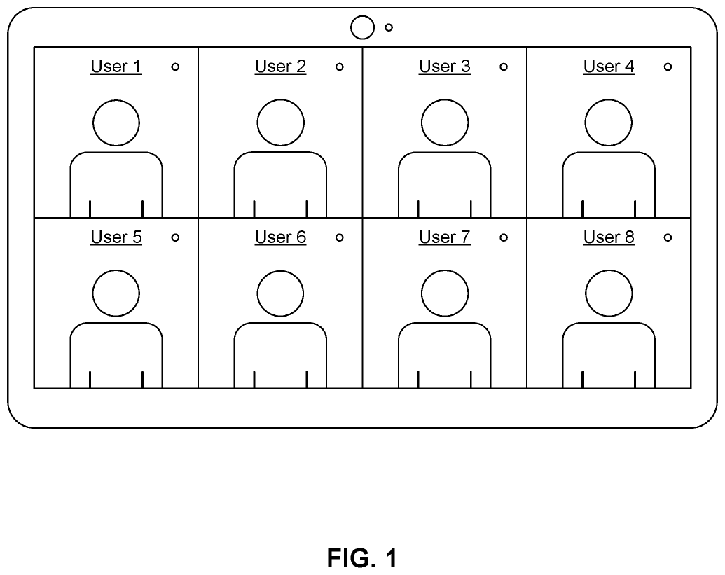

FIG. 1 illustrates a user interface of a video conference, in accordance with one or more embodiments. In the example of FIG. 1, eight users are displayed. However, any number of users may be connected to a virtual meeting and displayed via a client device. Once a client device is connected to a virtual meeting, the client device starts capturing a video (e.g., using an integrated camera), and audio (e.g., using an integrated microphone) and transmit the captured video and audio to the client device of other users connected to the virtual meeting. In some embodiments, each client device transmits captured video and audio to a centralized online system (e.g., a communication system).

Moreover, once the client device is connected to the virtual meeting, the client device starts receiving video and audio data captured by the client device of the other users connected to the virtual meeting. In some embodiments, the client device receives the video and audio of other users connected to the virtual meeting from the communication system instead of receiving it directly from each of the client devices of the other users connected to the virtual meeting.

### System Architecture

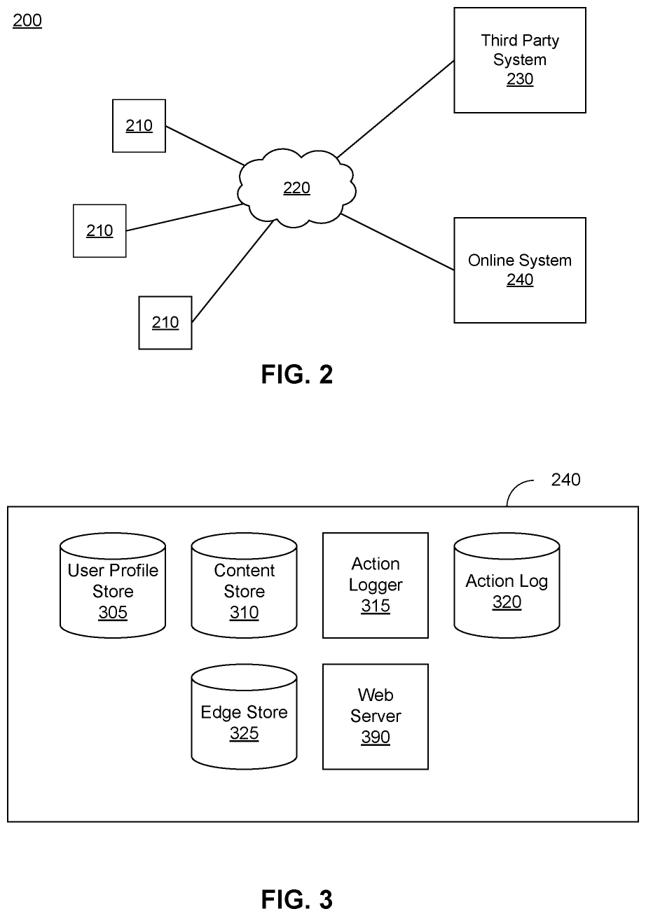

FIG. 2 is a block diagram of a system environment 200 for an online system 240. The system environment 200 shown by FIG. 2 comprises one or more client devices 210, a network 220, one or more third-party systems 230, and the online system 240. In alternative configurations, different and/or additional components may be included in the system environment 200. For example, the online system 240 is a social networking system, a content sharing network, or another system providing content to users.

Each user connects to a meeting using a client device 220. In some embodiments, to connect to the meeting the client device 220 sends a request to the online system 240 and the online system 240 facilitates the communication between each of the users connected to the meeting. For instance, the client device 220of each user captures video and audio data using an integrated camera and microphone, and sends the captured video and audio data to the online system 240. The online system 240 then forwards the video and audio data to other users connected to the meeting room.

The client devices 210 are one or more computing devices capable of receiving user input as well as transmitting and/or receiving data via the network 220. In one embodiment, a client device 210 is a conventional computer system, such as a desktop or a laptop computer. Alternatively, a client device 210 may be a device having computer functionality, such as a personal digital assistant (PDA), a mobile telephone, a smartphone, or another suitable device. A client device 210 is configured to communicate via the network 220. In one embodiment, a client device 210 executes an application allowing a user of the client device 210 to interact with the online system 240. For example, a client device 210 executes a browser application to enable interaction between the client device 210 and the online system 240 via the network 220. In another embodiment, a client device 210 interacts with the online system 240 through an application programming interface (API) running on a native operating system of the client device 210, such as IOS® or ANDROID™.

The client devices 210 are configured to communicate via the network 220, which may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

One or more third party systems 230 may be coupled to the network 220 for communicating with the online system 240, which is further described below in conjunction with FIG. 3. In one embodiment, a third-party system 230 is an application provider communicating information describing applications for execution by a client device 210 or communicating data to client devices 210 for use by an application executing on the client device. In other embodiments, a third-party system 230 provides content or other information for presentation via a client device 210. A third-party system 230 may also communicate information to the online system 240, such as advertisements, content, or information about an application provided by the third party system 230.

The online system 240 facilitates communications between client devices 210 over the network 220. For example, the online system 240 may facilitate connections between client devices 210 when a voice or video call is requested. Additionally, the online system 240 may control access of client devices 210 to various external applications or services available over the network 220. In an embodiment, the online system 240 may provide updates to client devices 210 when new versions of software or firmware become available. In other embodiments, various functions described below as being attributed to the client devices 210 can instead be performed entirely or in part on the online system 240. For example, in some embodiments, various processing or storage tasks may be offloaded from the client devices 210 and instead performed on the online system 240.

FIG. 3 is a block diagram of an architecture of the online system 240. The online system 240 shown in FIG. 3 includes a user profile store 305, a content store 310, an action logger 315, an action log 320, an edge store 325, and a web server 390. In other embodiments, the online system 240 may include additional, fewer, or different components for various applications. Conventional components such as network interfaces, security functions, load balancers, failover servers, management and network operations consoles, and the like are not shown so as to not obscure the details of the system architecture.

Each user of the online system 240 is associated with a user profile, which is stored in the user profile store 305. A user profile includes declarative information about the user that was explicitly shared by the user and may also include profile information inferred by the online system 240. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 305 may also maintain references to actions by the corresponding user performed on content items in the content store 310 and stored in the action log 320.

While user profiles in the user profile store 305 are frequently associated with individuals, allowing individuals to interact with each other via the online system 240, user profiles may also be stored for entities such as businesses or organizations. This allows an entity to establish a presence on the online system 240 for connecting and exchanging content with other online system users. The entity may post information about itself, about its products or provide other information to users of the online system 240 using a brand page associated with the entity's user profile. Other users of the online system 240 may connect to the brand page to receive information posted to the brand page or to receive information from the brand page. A user profile associated with the brand page may include information about the entity itself, providing users with background or informational data about the entity.

The content store 310 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 310, such as status updates, photos tagged by users to be associated with other objects in the online system 240, events, groups or applications. In some embodiments, objects are received from third-party applications or third-party applications separate from the online system 240. In one embodiment, objects in the content store 310 represent single pieces of content, or content “items.” Hence, online system users are encouraged to communicate with each other by posting text and content items of various types of media to the online system 240 through various communication channels. This increases the amount of interaction of users with each other and increases the frequency with which users interact within the online system 240.

The action logger 315 receives communications about user actions internal to and/or external to the online system 240, populating the action log 320 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 320.

The action log 320 may be used by the online system 240 to track user actions on the online system 240, as well as actions on third party systems 230 that communicate information to the online system 240. Users may interact with various objects on the online system 240, and information describing these interactions is stored in the action log 320. Examples of interactions with objects include commenting on posts, sharing links, checking-in to physical locations via a client device 210, accessing content items, and any other suitable interactions. Additional examples of interactions with objects on the online system 240 that are included in the action log 320 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 320 may record a user's interactions with advertisements on the online system 240 as well as with other applications operating on the online system 240. In some embodiments, data from the action log 320 is used to infer interests or preferences of a user, augmenting the interests included in the user's user profile and allowing a more complete understanding of user preferences.

The action log 320 may also store user actions taken on a third-party system 230, such as an external website, and communicated to the online system 240. For example, an e-commerce website may recognize a user of an online system 240 through a social plug-in enabling the e-commerce website to identify the user of the online system 240. Because users of the online system 240 are uniquely identifiable, e-commerce websites, such as in the preceding example, may communicate information about a user's actions outside of the online system 240 to the online system 240 for association with the user. Hence, the action log 320 may record information about actions users perform on a third-party system 230, including webpage viewing histories, advertisements that were engaged, purchases made, and other patterns from shopping and buying. Additionally, actions a user performs via an application associated with a third-party system 230 and executing on a client device 210 may be communicated to the action logger 315 by the application for recordation and association with the user in the action log 320.

In one embodiment, the edge store 325 stores information describing connections between users and other objects on the online system 240 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 240, such as expressing interest in a page on the online system 240, sharing a link with other users of the online system 240, and commenting on posts made by other users of the online system 240. Edges may connect two users who are connections in a social network, or may connect a user with an object in the system. In one embodiment, the nodes and edges form a complex social network of connections indicating how users are related or connected to each other (e.g., one user accepted a friend request from another user to become connections in the social network) and how a user is connected to an object due to the user interacting with the object in some manner (e.g., “liking” a page object, joining an event object or a group object, etc.). Objects can also be connected to each other based on the objects being related or having some interaction between them.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 240, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 325 also stores information about edges, such as affinity scores for objects, interests, and other users. Affinity scores, or “affinities,” may be computed by the online system 240 over time to approximate a user's interest in an object or in another user in the online system 240 based on the actions performed by the user. A user's affinity may be computed by the online system 240 over time to approximate the user's interest in an object, in a topic, or in another user in the online system 240 based on actions performed by the user. Computation of affinity is further described in U.S. patent application Ser. No. 12/978,265, filed on Dec. 23, 2010, U.S. patent application No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 325, in one embodiment. Alternatively, each interaction between a user and a specific object is stored as a separate edge. In some embodiments, connections between users may be stored in the user profile store 305, or the user profile store 305 may access the edge store 325 to determine connections between users.

The web server 390 links the online system 240 via the network 220 to the one or more client devices 210, as well as to the one or more third party systems 230. The web server 390 serves web pages, as well as other content, such as JAVA®, FLASH®, XML and so forth. The web server 390 may receive and route messages between the online system 240 and the client device 210, for example, instant messages, queued messages (e.g., email), text messages, short message service (SMS) messages, or messages sent using any other suitable messaging technique. A user may send a request to the web server 390 to upload information (e.g., images or videos) that are stored in the content store 310. Additionally, the web server 390 may provide application programming interface (API) functionality to send data directly to native client device operating systems, such as IOS®, ANDROID™, or BlackberryOS.

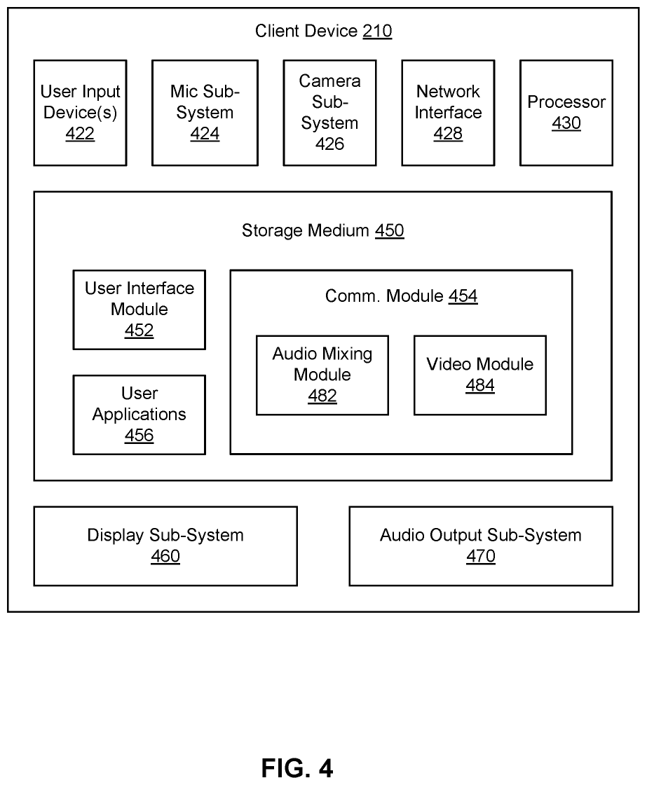

FIG. 4 is a block diagram of a client devices 210, in accordance with an embodiment. The client devices 210 includes one or more user input devices 422, a microphone sub-system 424, a camera sub-system 426, a network interface 428, a processor 430, a storage medium 450, a display sub-system 460, and an audio sub-system 470. In other embodiments, the client devices 210 may include additional, fewer, or different components.

The user input device 422 includes hardware that enables a user to interact with the client devices 210. The user input device 422 can include, for example, a touchscreen interface, a game controller, a keyboard, a mouse, a joystick, a voice command controller, a gesture recognition controller, a remote-control receiver, or other input device. In an embodiment, the user input device 422 may include a remote control device that is physically separate from the user input device 422 and interacts with a remote controller receiver (e.g., an infrared (IR) or other wireless receiver) that may integrated with or otherwise connected to the client devices 210. In some embodiments, the display sub-system 460 and the user input device 422 are integrated together, such as in a touchscreen interface. In other embodiments, the user input device 422 may include a port (e.g., an HDMI port) connected to an external television that enables user inputs to be received from the television responsive to user interactions with an input device of the television. For example, the television may send user input commands to the client devices 210 via a Consumer Electronics Control (CEC) protocol based on user inputs received by the television.

The microphone sub-system 424 includes one or more microphones (or connections to external microphones) that capture ambient audio signals by converting sound into electrical signals that can be stored or processed by other components of the client devices 210. The captured audio signals may be transmitted to the client devices 210 during an audio/video call or in an audio/video message. Additionally, the captured audio signals may be processed to identify voice commands for controlling functions of the client devices 210. In an embodiment, the microphone sub-system 424 includes one or more integrated microphones. Alternatively, the microphone sub-system 424 may include an external microphone coupled to the client devices 210 via a communication link (e.g., the network 220 or other direct communication link). The microphone sub-system 424 may include a single microphone or an array of microphones. In the case of a microphone array, the microphone sub-system 424 may process audio signals from multiple microphones to generate one or more beamformed audio channels each associated with a particular direction (or range of directions).

The camera sub-system 426 includes one or more cameras (or connections to one or more external cameras) that captures images and/or video signals. The captured images or video may be sent to other client devices 210 or to the online system 240 during a video call or in a multimedia message, or may be stored or processed by other components of the client devices 210. Furthermore, in an embodiment, images or video from the camera sub-system 426 may be processed for face detection, face recognition, gesture recognition, or other information that may be utilized to control functions of the client devices 210. In an embodiment, the camera sub-system 426 includes one or more wide-angle cameras for capturing a wide, panoramic, or spherical field of view of a surrounding environment. The camera sub-system 426 may include integrated processing to stitch together images from multiple cameras, or to perform image processing functions such as zooming, panning, de-warping, or other functions. In an embodiment, the camera sub-system 426 may include multiple cameras positioned to capture stereoscopic (e.g., three-dimensional images) or may include a depth camera to capture depth values for pixels in the captured images or video.

The network interface 428 facilitates connection of the client devices 210 to the network 220. For example, the network interface 428 may include software and/or hardware that facilitates communication of voice, video, and/or other data signals with one or more client devices 210 to enable voice and video calls or other operation of various applications executing on the client devices 210. The network interface 428 may operate according to any conventional wired or wireless communication protocols that enable it to communication over the network 220.

The display sub-system 460 includes an electronic device or an interface to an electronic device for presenting images or video content. For example, the display sub-system 460 may include an LED display panel, an LCD display panel, a projector, a virtual reality headset, an augmented reality headset, another type of display device, or an interface for connecting to any of the above-described display devices. In an embodiment, the display sub-system 460 includes a display that is integrated with other components of the client devices 210. Alternatively, the display sub-system 460 includes one or more ports (e.g., an HDMI port) that couples the online system 240 to an external display device (e.g., a television).

The audio output sub-system 470 includes one or more speakers or an interface for coupling to one or more external speakers that generate ambient audio based on received audio signals. In an embodiment, the audio output sub-system 470 includes one or more speakers integrated with other components of the client devices 210. Alternatively, the audio output sub-system 470 includes an interface (e.g., an HDMI interface, optical interface, or wireless interface such as Bluetooth) for coupling the client devices 210 with one or more external speakers (for example, a dedicated speaker system, a headphone or earphone, or a television). The audio output sub-system 470 may output audio in multiple channels to generate beamformed audio signals that give the listener a sense of directionality associated with the audio. For example, the audio output sub-system may generate audio output as a stereo audio output or a multi-channel audio output such as 2.1, 3.1, 5.1, 7.1, or other standard configuration.

In embodiments in which the client devices 210 is coupled to an external media device such as a television, the client devices 210 may lack an integrated display and/or an integrated speaker, and may instead only communicate audio/visual data for outputting via a display and speaker system of the external media device.

The processor 430 operates in conjunction with the storage medium 450 (e.g., a non-transitory computer-readable storage medium) to carry out various functions attributed to the client devices 210 described herein. For example, the storage medium 450 may store one or more modules or applications (e.g., user interface 452, communication module 454, user applications 456) embodied as instructions executable by the processor 430. The instructions, when executed by the processor, cause the processor 430 to carry out the functions attributed to the various modules or applications described herein. In an embodiment, the processor 430 may include a single processor or a multi-processor system.

In an embodiment, the storage medium 450 includes a user interface module 452, a communication module 454, and user applications 456. In alternative embodiments, the storage medium 450 may include different or additional components.

The user interface module 452 includes visual and/or audio elements and controls for enabling user interaction with the client devices 210. For example, the user interface module 452 may receive inputs from the user input device 422 to enable the user to select various functions of the client devices 210. In an example embodiment, the user interface module 452 includes a calling interface to enable the client devices 210 to make or receive voice and/or video calls over the network 220. To make a call, the user interface module 452 may provide controls to enable a user to select one or more contacts for calling, to initiate the call, to control various functions during the call, and to end the call. To receive a call, the user interface module 452 may provide controls to enable a user to accept an incoming call, to control various functions during the call, and to end the call. For video calls, the user interface module 452 may include a video call interface that displays remote video from a client device 210 together with various control elements such as volume control, an end call control, or various controls relating to how the received video is displayed or the received audio is outputted.

The user interface module 452 may furthermore enable a user to access user applications 456 or to control various settings of the client devices 210. In an embodiment, the user interface module 452 may enable customization of the user interface according to user preferences. Here, the user interface module 452 may store different preferences for different users of the client devices 210 and may adjust settings depending on the current user.

The communication module 454 facilitates communications of a client device 210 with other client devices 210 for voice and/or video calls. For example, the communication module 454 may maintain a directory of contacts and facilitate connections to those contacts in response to commands from the user interface module 452 to initiate a call. Furthermore, the communication module 454 may receive indications of incoming calls and interact with the user interface module 452 to facilitate reception of the incoming call. The communication module 454 may furthermore process incoming and outgoing voice and/or video signals during calls to maintain a robust connection and to facilitate various in-call functions.

The communication module 454 includes an audio mixing module 482 and a video module 484. The audio mixing module 482 receives multiple audio feeds, each corresponding to a different user connected with the client devices 210 and combines the audio feeds to generate an output audio stream. The output audio stream is then sent to the audio output sub-system 470 for playback. The video module 484 receives multiple video feeds, each corresponding to a different user connected with the client devices 210 and combines the video feeds to generate an output video stream. The output video stream is then sent to the display sub-system 460 for display. In some embodiments, some of the functions of the audio mixing module 482 or the video module 484 are performed by other components, such as the online system 240.

The user applications 456 includes one or more applications that may be accessible by a user via the user interface module 452 to facilitate various functions of the client devices 210. For example, the user applications 456 may include a web browser for browsing web pages on the Internet, a picture viewer for viewing images, a media playback system for playing video or audio files, an intelligent virtual assistant for performing various tasks or services in response to user requests, or other applications for performing various functions. In an embodiment, the user applications 456 includes a social networking application that enables integration of the client devices 210 with a user's social networking account. Here, for example, the client devices 210 may obtain various information from the user's social networking account to facilitate a more personalized user experience. Furthermore, the client devices 210 can enable the user to directly interact with the social network by viewing or creating posts, accessing feeds, interacting with friends, etc. Additionally, based on the user preferences, the social networking application may facilitate retrieval of various alerts or notifications that may be of interest to the user relating to activity on the social network. In an embodiment, users may add or remove applications 456 to customize operation of the client devices 210.

### Spatial Audio Based Voice Conference

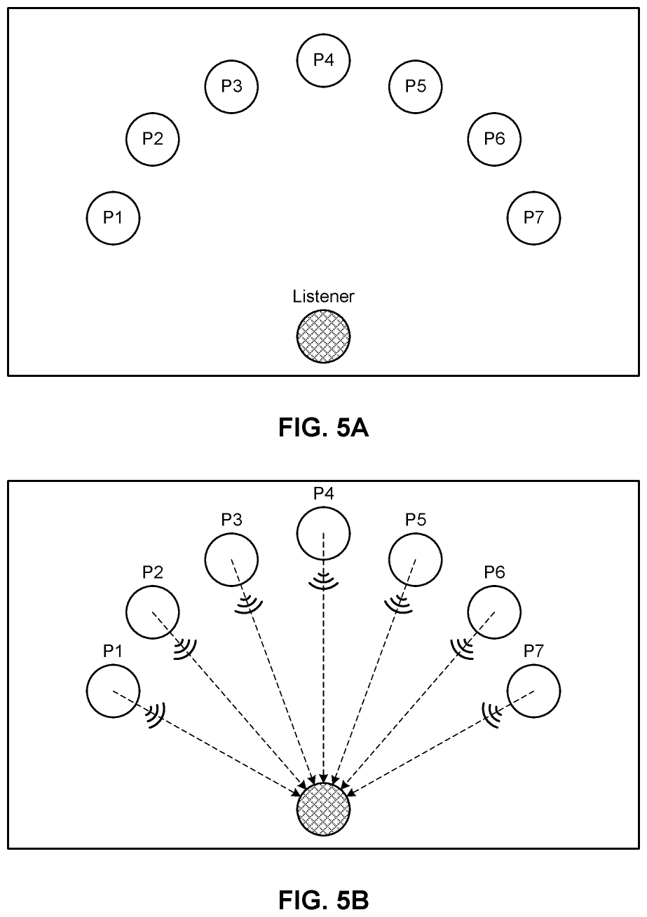

FIG. 5A illustrates a diagram for configuring a spatial audio based voice conference, in accordance with one or more embodiments. FIG. 5B illustrates a diagram showing the audio output of the spatial audio based voice conference configuration of FIG. 5A. Although the following description is presented using a voice conference, the description also applies to video conferences that provides a video feed of the participants in addition to their audio feed.

A user arranges the participants of a voice conference to configure the direction from which the audio associated with the participants will be presented to the user. For example, the arrangement of FIG. 5A shows seven users arranged in a semi-circular pattern. The user is presented with a user interface (UI) that allows the user to place participants of the meeting within a predetermined area. The users may be able to move icons representing each of the participants around the predetermined. Alternatively, the user interface may provide predetermined locations that the user is able to assign to a participant.

Although the example of FIGS. 5A and 5B show a two-dimensional arrangement of participants, the UI may allow the user to arrange the participants in a three-dimensional arrangement. That is, the UI allows the user to place participants at different elevations. In some embodiments, the UI allows the user to place participants in any location within the three-dimensional space. Alternatively, the UI provides predetermined locations within the three-dimensional space that can be assigned to one or more participants of the voice conference.

Based on the arrangement of the participants of the meeting, the client device 210 outputs audio (e.g., using two or more audio channels) in a manner that causes the user to perceive the audio corresponding to each of the participants to be originated from the location assigned to the participant. For example, for the configuration shown in FIG. 5A, the audio corresponding to participant P1 (e.g., the audio captured by the client device of participant P1) is outputted by the audio output sub-system 470 of the client device 210 in a manner that would cause the user to perceive the audio being originated from the left of the user, the audio corresponding to participant P4 is outputted by the audio output sub-system 470 of the client device 210 in a manner that would cause the user to perceive the audio being originated right in front of the user, and the audio corresponding to participant P7 is outputted by the audio output sub-system 470 of the client device 210 in a manner that would cause the user to perceive the audio being originated from the right of the user.

In some embodiments, the audio corresponding to each participant is modulated to provide the user listening to the modulated audio the perception that the audio corresponding to each participant originates from a specific location. For example, the audio corresponding to each participant is modulated using a head-related transfer function (HRTF) based on the location assigned to the participant. The audio corresponding to each participant may be a single channel audio (monoaural sound), and the monoaural sound may be converted to an output audio signal having two or more channels by changing the amplitude and phase of the monoaural sound for each of the channels of the output audio signal.

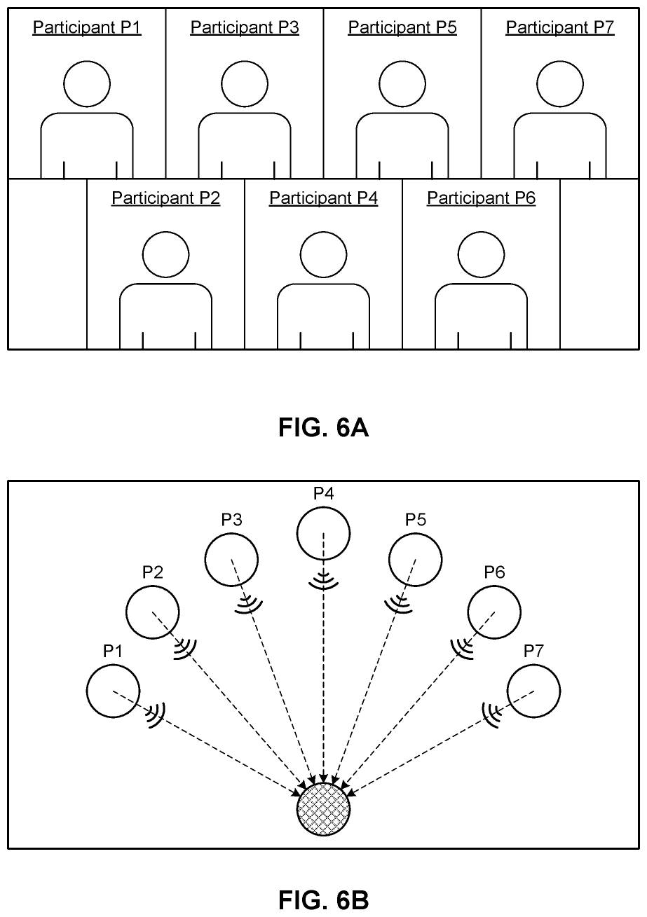

FIG. 6A illustrates a diagram for configuring a spatial audio based voice conference, according to another embodiment. FIG. 6B illustrates a diagram showing the audio output of the spatial audio based voice conference configuration of FIG. 6A. In the embodiment of FIG. 6A, the participants are arranged in a grid. Based on the arrangement of each of the participants, a location in three-dimensional space is determined for each of the participants, and the audio corresponding to each of the participants is modulated based on the determined location. For example, as shown in FIG. 6B, each participant is assigned a location within a semi-circle based on the arrangement provided by the user. Alternatively, the participants may be arranged in a straight line, a circle, a curved segment, or any other suitable configuration. In some embodiments, the participants are arranged in a three-dimensional configuration (e.g., including a first subset of participants assigned to a first elevation, and a second subset of participants assigned to a second elevation).

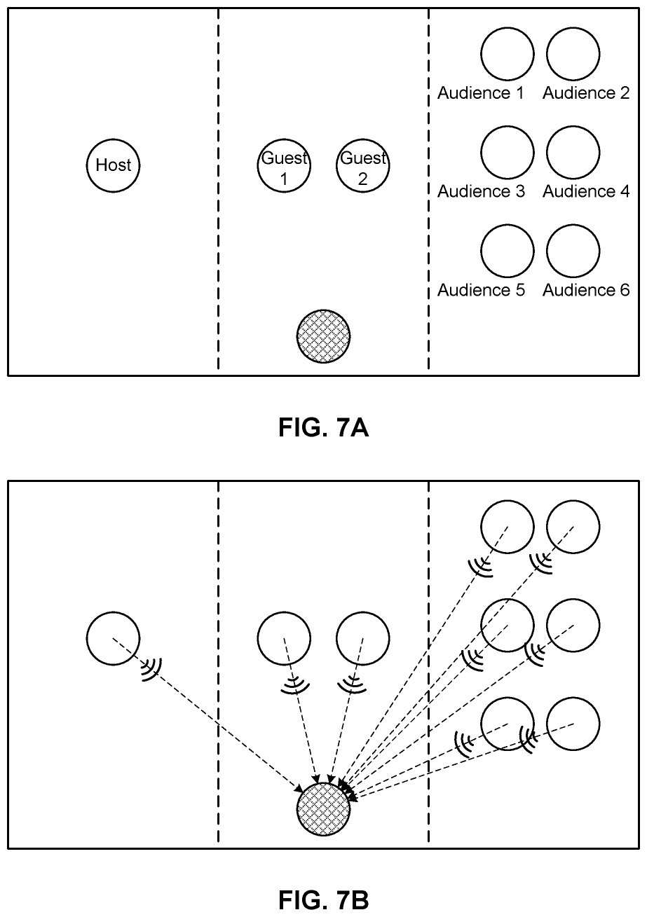

FIG. 7A illustrates a diagram for configuring a spatial audio based voice conference having participants divided into multiple groups, in accordance with one or more embodiments. FIG. 7B illustrates a diagram showing the audio output of the spatial audio based voice conference configuration of FIG. 7A. In the embodiment of FIG. 7A, the participants are separated into multiple groups. For example, the participants are separated into a hosts group, a guests group, and an audience group. Each group is then assigned a region where the corresponding participants may be placed. The user may then be given the ability to move the participants within their corresponding region, or the participants may be automatically assigned a location within their corresponding region. The audio corresponding to each participant is then modulated based on the location assigned to the participant to cause a user to perceive the audio corresponding to each participant to originate from their assigned locations.

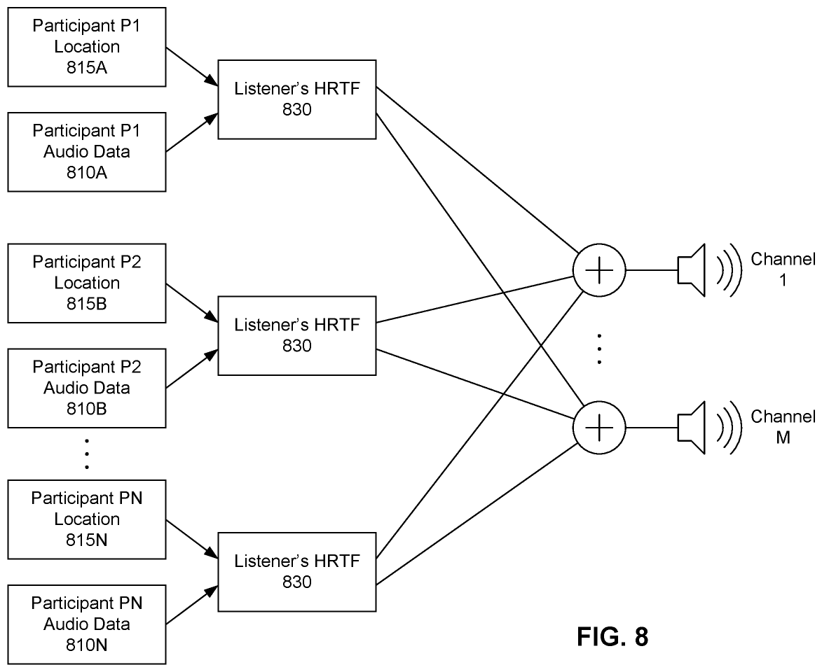

FIG. 8 illustrates a diagram for modulating the audio of each participant of a meeting, in accordance with one or more embodiments. For each participant that is providing audio (e.g., participants that are not muted), a location for the participant is determined. The location for the participant is determined at least based on the arrangement of the participants provided by a user of a client device. In some embodiments, the location for the participant is additionally determined based on a position or pose of the user. For example, as the head of the user moves or rotates, the location of a participant is determined relative to the position and rotation of the user's head.

Using an HRTF 830 and based on the determined location for a participant, the audio data for the participant is modulated. In some embodiments, the HRTF 830 generated multiple audio output channels (each corresponding to an audio channel of the output audio signal). In some embodiments, the number of audio output channels for the HRTF 830 is based on a configuration of the audio output sub-system 470 of the client device 210. For example, if the audio output sub-system 470 uses a stereo headset to output audio, the HRTF 830 generates an output having two audio output channels. Alternatively, if the audio output sub-system 470 uses a 5.1 speaker system, the HRTF 830 generates an output having six audio output channels.

The outputs of the HRTF 830 for each participant are combined to generate a combined audio output. The first audio output channel of the HRTF 830 for the first participant is combined with the first audio output channel of the HRTF 830 for the other participants. Similarly, the second audio output channel of the HRTF 830 for the first participant is combined with the second audio output channel of the HRTF 830 for the other participants. The combined audio output is then provided to the audio output sub-system 470 (e.g., to drive a pair of speakers to provide the audio signals to the user of the client device).

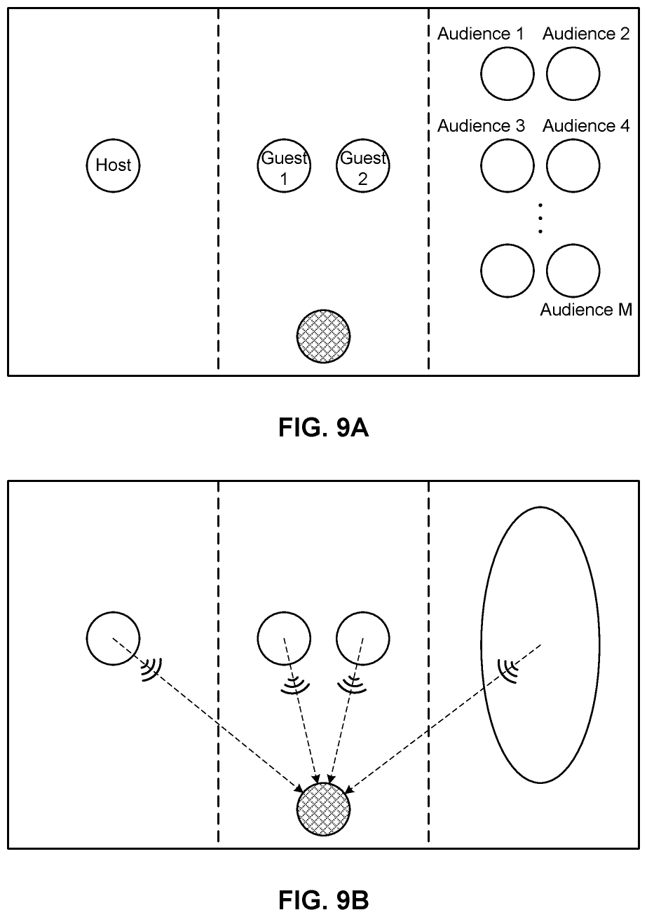

FIG. 9A illustrates a diagram for configuring a spatial audio based voice conference with multiple participants having a single location, in accordance with one or more embodiments. FIG. 9B illustrates a diagram showing the audio output of the spatial audio based voice conference configuration of FIG. 9A. In the embodiment of FIG. 9A, the participants are separated into multiple groups. For example, the participants are separated into a hosts group, a guests group, and an audience group. In this embodiment, the participants of at least one group are assigned to the same location. For example, as shown in FIG. 9B, the participants assigned to the audience group are assigned a single location. As such, the audio corresponding to the participants in the audience group are combined together and are modulated so that the user perceives the combined audio for the participants in the audience group to originate from a single location.

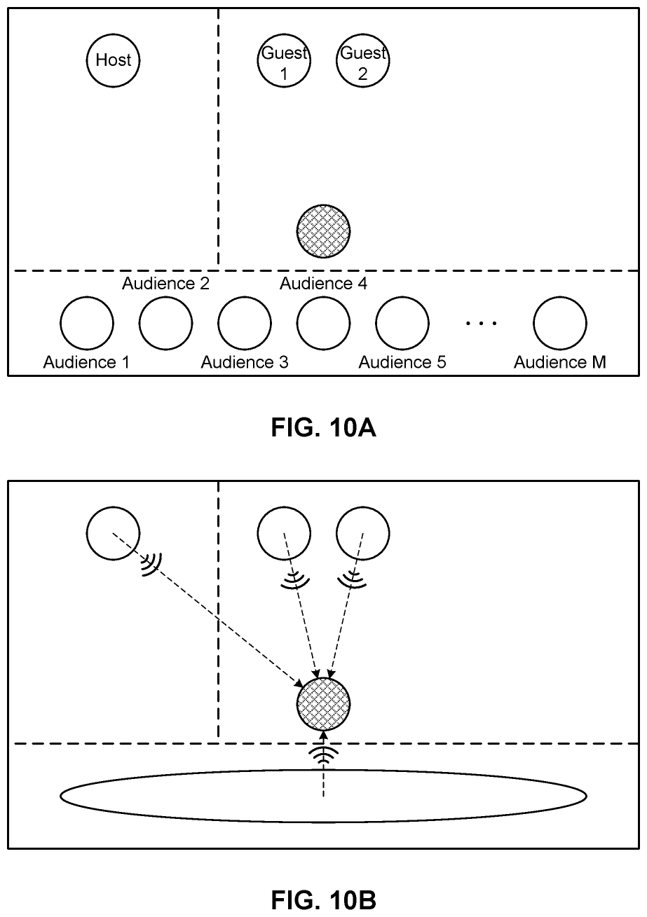

FIG. 10A illustrates a diagram for configuring a spatial audio based voice conference with multiple participants having a single location, according to another embodiment. FIG. 10B illustrates a diagram showing the audio output of the spatial audio based voice conference configuration of FIG. 10A. In the example of FIG. 10A, the participants assigned to the audience group are assigned a location that is behind the user. As such, as shown in FIG. 10B, the audio corresponding to the participants in the audience group are combined together and are modulated so that the user perceives the combined audio for the participants in the audience group to originate from behind the user.

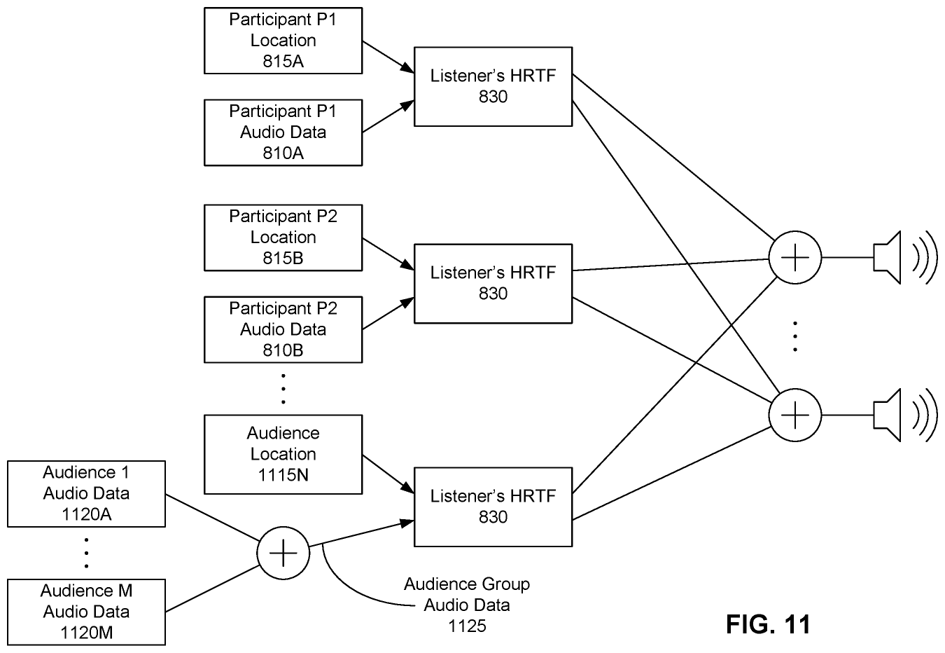

FIG. 11 illustrates a diagram for modulating the audio of each participant of a meeting with multiple users assigned to a single location, in accordance with one or more embodiments. For each participant that is providing audio (e.g., participants that are not muted), a location for the participant is determined. In the example of FIG. 11, the participants assigned to the audience group are assigned to a single location. Here, the audio data 1120 for each of the users in the audience group are combined to generate a group audio data 1125. The group audio data 1125 is then modulated using the HRTF 830 based on the location assigned to the group.

The output of the HRTF 830 for the group audio data 1125 is the combined with the output of the HRTF 830 for other participants in the meeting. That is, the first audio output channel of the HRTF 830 for the group audio data 1125 is combined with the first audio output channel of the HRTF 830 for the first participant (e.g., the host), the second participant (e.g., a first guest), and so forth. Similarly, the second audio output channel of the HRTF 830 for the group audio data 1125 is combined with the second audio output channel of the HRTF 830 for the first participant, the second participant, and so forth. The combined audio output is then provided to the audio output sub-system 470 (e.g., to drive a pair of speakers to provide the audio signals to the user of the client device).

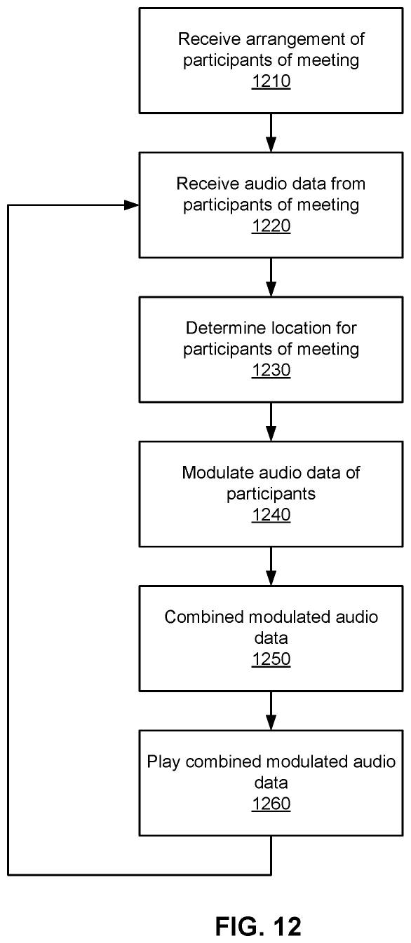

FIG. 12 illustrates a flow diagram for outputting audio for a spatial audio based voice conference, in accordance with one or more embodiments. An arrangement of the participants of a virtual meeting is received 1210. For example, a user (listener) of a client device may arrange the participants of the virtual meeting in a user interface associated with the spatial audio based voice conference. For example, the listener may arrange one or more persons of interest in a specific location within a virtual space. In some embodiments, the listener is provided an initial arrangement of participants and the listener is given the ability to rearrange the participants. In some embodiments, the arrangement of the participants is received with respect to a location of the listener in the virtual space. For example, the arrangement specifies that a person is located directly in front of the location of the listener in the virtual space or to the left of the location of the listener in the virtual space. In some embodiments, the user interface is provided to the client device 210 by the online system 240. Alternatively, the user interface is part of a conferencing application installed in the client device 210.

In some embodiments, the arrangement of participants may be adjusted dynamically. As the virtual meeting is taking place, the listener may change the arrangement of one or more participants of the virtual meeting. During the virtual meeting, the listener can move the location within the virtual space of one or more participants. For example, the listener may rearrange the participants as participants leave the virtual meeting or new participants join the virtual meeting, or as the topic of the virtual meeting changes, changing the role or importance of one or more participants.

While the virtual meeting is taking place, audio from one or more participants is received 1220 by the client device 210. That is, the mic sub-system 424 of the client device 210 of each participant (or unmuted participant) captures audio of the surrounding of the client device 210 of the participant, encodes the captured audio into an audio data stream, and the provides the audio data stream to the client device 210 of the listener. In some embodiments, the client device 210 of each participant sends the audio data stream to the online system 240 and the online system 240 transmits the received audio data stream corresponding to a participant of a virtual meeting to other participants of the virtual meeting. Alternatively, the client device 210 of a participant sends the audio data stream to the client device 210 of other participants directly.

For each participant for which audio data was received, a corresponding location is determined 1230. In some embodiment, the location for each participant is determined based on a virtual space. The virtual space corresponds to the pose of the listener or to the arrangement of the audio output sub-system 470 and may change with respect to the real space as the pose of the user or the arrangement of the audio output sub-system changes. For example, when the audio output sub-system 470 outputs audio using a pair of headphones that move in conjunction with the head of the user, the virtual space corresponds to a position and orientation of the head of the listener.

The location for a participant is determined at least in part based on the arrangement of participants received from the client device of the listener. For example, a set of coordinates (e.g., cartesian or polar coordinates) with respect to an origin point of the virtual space is determined for each participant for which audio data was received.

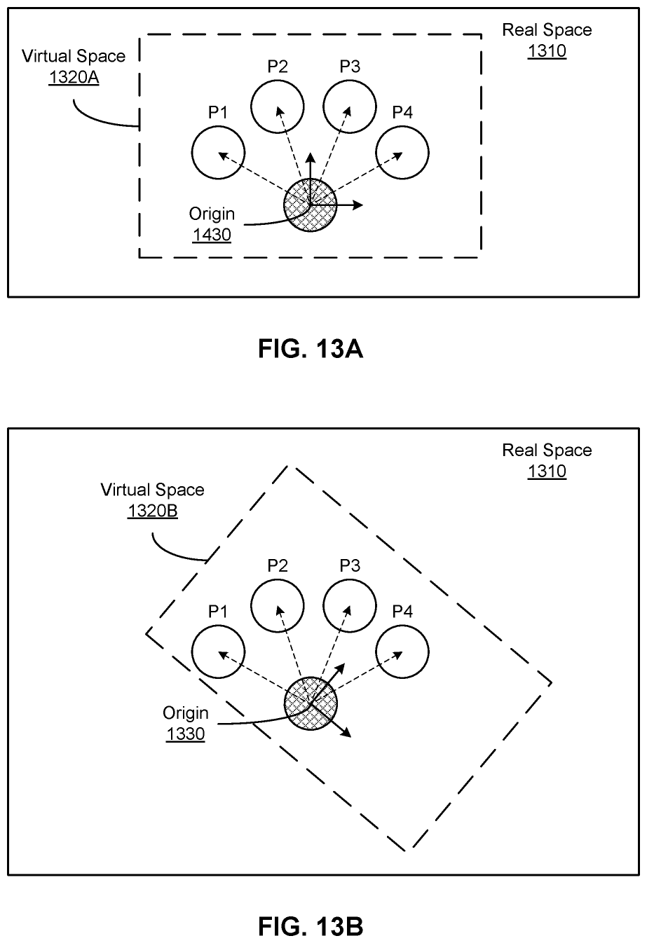

In some embodiments, the location for a participant is additionally determined based on an orientation of the head of the listener. In this embodiment, the participant's location is locked in real space and the origin point of the virtual space used for determining the set of coordinates for each participant is changes with respect to the real space based on the orientation of the head of the listener. FIGS. 13A and 13B illustrate a block diagram for determining a location for participants of a meeting locked in real space, in accordance to one or more embodiments.

As shown in FIGS. 13A and 13B, as the listener's pose changes (e.g., the orientation of the user's head changes), the origin point 1330 used for determining the location of each of the participants changes accordingly. In the diagram of FIG. 13B, the listener's pose rotated to the right compared to the listener's pose in the diagram of FIG. 13B. However, as the pose of the listener changes, the location of the participants P1 through P4 stay locked with respect to real space 1310. As such, the location of the participants P1 through P4 change with respect to virtual space 1320. In this embodiment, to update the location of the participants with respect to virtual space 1320, the pose of the listener is tracked using a set of sensors (such as sensors embedded in a set of headphones or a head-mounted display).

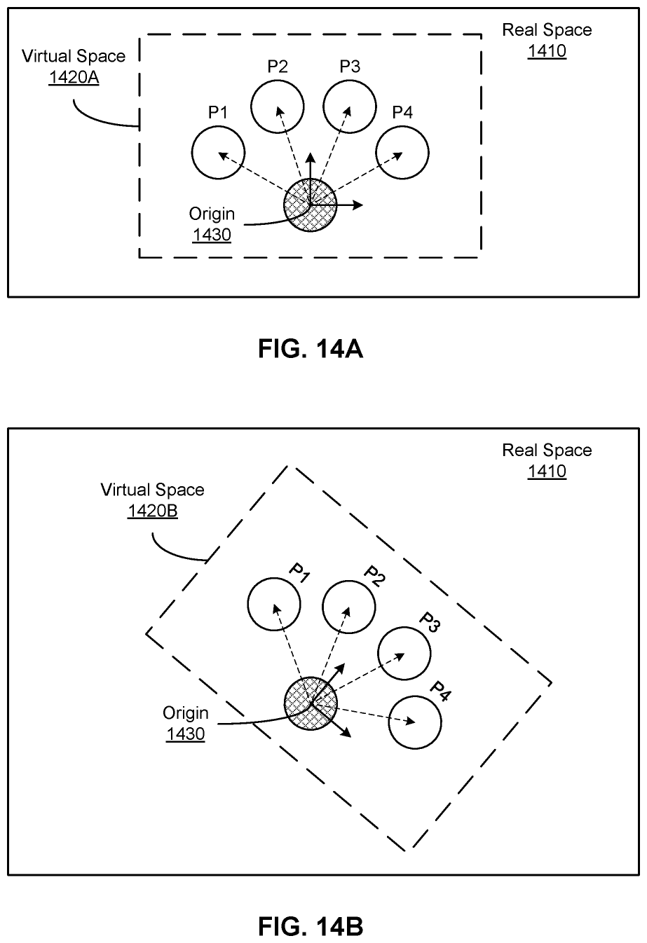

In other embodiments, the location for a participant is determined irrespective of the position or orientation of the head of the listener. In this embodiment, the location of the participants is locked to the virtual space. FIGS. 14A and 14B illustrate a block diagram for determining a location for participants of a meeting locked in virtual space, in accordance to one or more embodiments. As shown in FIGS. 13A and 13B, as the virtual space 1420 changes with respect to real space 1410 (e.g., due to a change in the pose of the listener), the location of the participants of the meeting also change accordingly. As such, the position of participants P1 through P4 with respect to the virtual space 1420 does not change as the pose of the listener changes.

In some embodiments, the determination of the location for participants of the meeting is configured based on a type of the audio output sub-system 470. For example, if the audio output sub-system 470 is a headset that includes an inertial measurement unit (IMU), the location of participants of the meeting is determined based on the arrangement of participants provided by the listener and the orientation of the head of the listener determined based on the output of the IMU of the headset. Alternatively, if the audio output sub-system 470 is a pair of stereo speakers, the location of participants of the meeting is determined based on the arrangement of participants provided by the listener without taking into consideration the orientation of the head of the listener.

In other embodiments, the listener is able to select whether to determine the locations for participants of the meeting based on the orientation of the listener's head. For example, if the listener joins a meeting while walking, or while driving, the listener might prefer that the locations for the participants are locked in a static virtual space. As such, as the listener moves, the location the location of the participants does not move with respect to the listener. In other words, a participant that is assigned to a location to the left of the listener would be perceived as having audio originating from the left side of the listener irrespective of how much the listener has moved. Similarly, a participant that is assigned to a location to the right of the listener would be perceived as having audio originating from the right side of the listener irrespective of how much the listener has moved.

Conversely, if the listener joins a meeting while sitting at a desk, the listener might prefer that the locations for the participants are locked in real space (e.g., locked in place in the room). As such, as the head of the listener moves or rotates, the location of the participants with respect to the origin point set based on the position of the listener's head is updated to provide the perception that participants are locked in specific locations in the room the listener is in.

Referring back to FIG. 12, the audio data for each of the participants is modulated 1240. The audio data of a participant is modulated using an HRTF and based on the determined location of the participant. In some embodiments, a user specific HRTF is used for modulating the audio data of each participant. For example, each user has an HRTF stored locally in the client device or stored in conjunction with the user's user profile in the online system 240.

The modulated audio data of each of the participants is combined 1250 and provided to the audio output sub-system 470 for playback. In particular, for each audio channel of the audio output sub-system 470, the corresponding modulated audio data of every participant is combined 1250 and played 1260 using a corresponding speaker of the audio output sub-system 470.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
joining a virtual meeting having a plurality of participants;
receiving an arrangement for at least a subset of participants of the virtual meeting;
receiving an audio stream for each participant of the subset of participants of the virtual meeting;
assigning two or more of the subset of participants to an audience group;
for each participant of the subset of participants not assigned to the audience group:
determining a location for the participant based on the received arrangement, and
modulating the received audio stream of the participant based on the determined location for the participant;
combining the received audio streams for the participants assigned to the audience group;
determining a location for the audience group based on the received arrangement;
modulating the combined received audio streams of the participants assigned to the audience group based on the determined location for the audience group;
generating a combined modulated audio stream by combining the modulated audio stream of each of the participants of the subset of participants and the modulated audio stream of the audience group; and
playing the combined modulated audio stream.

2. The method of claim 1, wherein the location of the participant is further determined based on sensor data of one or more sensors for determining a pose of a listener.

3. The method of claim 2, wherein the one or more sensors are embedded in a head-mounted display.

4. The method of claim 2, wherein the one or more sensors are embedded in one of headphones or earphones.

5. The method of claim 1, wherein the received audio stream is modulating using a head-related transfer function.

6. The method of claim 1, wherein receiving an arrangement for at least a subset of participants of a virtual meeting comprises:
receiving a position within a graphical user interface for each participant of the subset of participants.

7. The method of claim 6, wherein the graphical user interface arranges the participants in one of a grid, a circle, a curved segment, and a three-dimensional arrangement.

8. The method of claim 1, wherein receiving an arrangement for at least a subset of participants of a virtual meeting comprises:
receiving a classification for each participant of the subset of participants of the virtual meeting; and
determining an arrangement for each of the participants based on the received classification for the participant.

9. The method of claim 8, wherein the subset of participants includes a first participant having a first classification and a second participant having a second location, and wherein determining an arrangement for each of the participants comprises:
assigning a first position for the first participant within a first region associated with the first classification, and
assigning a second position for the second participant within a second region associated with the second classification, the second region different than the first region.

10. (canceled)

11. A non-transitory computer-readable storage medium configured to store instructions, the instructions when executed by a processor cause the processor to:
join a virtual meeting having a plurality of participants;
receive an arrangement for at least a subset of participants of the virtual meeting;
receive an audio stream for each participant of the subset of participants of the virtual meeting;
assign two or more of the subset of participants to an audience group;
for each participant of the subset of participants not assigned to the audience group:
determine a location for the participant based on the received arrangement, and
modulate the received audio stream of the participant based on the determined location for the participant;
combine the received audio streams for the participants assigned to the audience group;
determine a location for the audience group based on the received arrangement;
modulate the combined received audio streams of the participants assigned to the audience group based on the determined location for the audience group;
generate a combined modulated audio stream by combining the modulated audio stream of each of the participants of the subset of participants and the modulated audio stream of the audience group; and
play the combined modulated audio stream.

12. The non-transitory computer-readable storage medium of claim 11, wherein the location of the participant is further determined based on sensor data of one or more sensors for determining a pose of a listener.

13. The non-transitory computer-readable storage medium of claim 12, wherein the one or more sensors are embedded in a head-mounted display.

14. The non-transitory computer-readable storage medium of claim 12, wherein the one or more sensors are embedded in one of headphones or earphones.

15. The non-transitory computer-readable storage medium of claim 11, wherein the received audio stream is modulating using a head-related transfer function.

16. The non-transitory computer-readable storage medium of claim 11, wherein the instructions for receiving an arrangement for at least a subset of participants of a virtual meeting cause the processor to:
receive a position within a graphical user interface for each participant of the subset of participants.

17. The non-transitory computer-readable storage medium of claim 16, wherein the graphical user interface arranges the participants in one of a grid, a circle, a curved segment, and a three-dimensional arrangement.

18. The non-transitory computer-readable storage medium of claim 11, wherein the instructions for receiving an arrangement for at least a subset of participants of a virtual meeting cause the processor to:
receive a classification for each participant of the subset of participants of the virtual meeting; and
determine an arrangement for each of the participants based on the received classification for the participant.

19. The non-transitory computer-readable storage medium of claim 18, wherein the subset of participants includes a first participant having a first classification and a second participant having a second location, and wherein the instruction for determining an arrangement for each of the participants cause the processor to:
assign a first position for the first participant within a first region associated with the first classification, and
assign a second position for the second participant within a second region associated with the second classification, the second region different than the first region.

20. (canceled)

21. The method of claim 8, wherein the two or more of the subset of participants are assigned to the audience group based on the classification of the participants.

22. The non-transitory computer-readable storage medium of claim 18, wherein the two or more of the subset of participants are assigned to the audience group based on the classification of the participants.
